(19) United States
(12) Patent Application Publication
(10) Pub. No.: US 2014/0272518 A1
(43) Pub. Date: Sep. 18, 2014

(54) BATTERY SYSTEM WITH COMPLIANT HEATSINK ASSEMBLY

(71) Applicant: EnerDel, Inc., Greenfield, IN (US)

(72) Inventors: Bruce James Silk, Indianapolis, IN (US); Derrick Scott Buck, Pendleton, IN (US); Wendell G. Ferguson, Daleville, IN (US)

(73) Assignee: EnerDel, Inc., Greenfield, IN (US)

(21) Appl. No.: 14/208,801

(22) Filed: Mar. 13, 2014

Related U.S. Application Data
(60) Provisional application No. 61/783,182, filed on Mar. 14, 2013.

(51) Int. Cl. H01M 10/613

(52) U.S. Cl. CPC H01M 10/5004
USPC 429/120

(57) ABSTRACT

A multi-cell battery system is disclosed including one or more battery sub-assemblies and one or more compliant heat exchange assemblies stacked together along a longitudinal axis. Each compliant heat exchange assembly may adapt to expansions and contractions of adjacent battery cells, and may define a heat exchange passageway through the battery system.

### CROSS-REFERENCE TO RELATED APPLICATION

This application claims priority to U.S. Provisional Patent Application Ser. No. 61/783,182, filed Mar. 14, 2013, the disclosure of which is hereby expressly incorporated by reference herein in its entirety.

### FIELD OF THE DISCLOSURE

The present disclosure relates to a battery system. More particularly, the present disclosure relates to a cooling system and method for a multi-cell battery system.

### BACKGROUND OF THE DISCLOSURE

A plurality of battery cells, such as lithium-ion battery cells, may be stacked together to form a multi-cell battery system. In U.S. Patent Application Publication No. 2012/0021271 to Tople et al., for example, a battery system is disclosed with a stacked arrangement of battery cells and frames. In operation, such battery systems may generate heat, especially during repeated charging and discharging of the battery system. A cooling system may be provided to remove heat from the battery system.

### SUMMARY

The present disclosure provides a multi-cell battery system including one or more battery sub-assemblies and one or more compliant heat exchange assemblies stacked together along a longitudinal axis. Each compliant heat exchange assembly may adapt to expansions and contractions of adjacent battery cells, and may define a heat exchange passageway through the battery system.

According to an embodiment of the present disclosure, a battery system is provided including a plurality of prismatic battery cells including a first cell having a first terminal extending from the first cell, and a second cell having a second terminal extending from the second cell, and a heat exchange assembly located between the first and second cells, the heat exchange assembly including a first surface facing the first cell, a second surface facing the second cell, and at least one compliant member between the first and second surfaces.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is an assembled perspective view of an exemplary compliant heat exchange assembly of the present disclosure;

FIG. 2 is an exploded perspective view of the compliant heat exchange assembly of FIG. 1;

FIG. 3 is a cross-sectional view of the compliant heat exchange assembly of FIG. 1 shown between two battery cells;

FIG. 4 is a cross-sectional view of another exemplary compliant heat exchange assembly of the present disclosure shown between two battery cells;

FIG. 5 is an assembled perspective view of yet another exemplary compliant heat exchange assembly of the present disclosure;

FIG. 6 is an exploded perspective view of the compliant heat exchange assembly of FIG. 5; and

FIG. 7 is a cross-sectional view of the compliant heat exchange assembly of FIG. 5 shown between two battery cells.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

Referring initially to FIG. 3, the present disclosure provides a battery system 10 including one or more framed battery sub-assemblies 12 stacked together along a longitudinal axis L, and at least one support (e.g., tie rods, external bands) (not shown) for securing the battery sub-assemblies 12 together.

Each battery sub-assembly 12 of the battery system 10 may include a first frame 20 and a second frame 22. The first and second frames 20, 22 may be generally rectangular and planar in shape, although this shape may vary. The first and second frames 20, 22 may be constructed of plastic or another suitable non-conductive material. The first and second frames 20, 22 may be snapped, screwed, welded, adhered, or otherwise coupled together to provide dimensional stability to the battery sub-assembly 12. Exemplary frames are disclosed in U.S. Patent Application Publication No. 2010/0304203 to Buck et al., the disclosure of which is expressly incorporated herein by reference in its entirety.

Each battery sub-assembly 12 of the battery system may also include one or more battery cells 30, 32 sandwiched between the first and second frames 20, 22. Exemplary battery cells 30, 32 include lithium-ion cells, specifically prismatic lithium-ion cells. The battery cells 30, 32 may be relatively soft and compliant and may be rectangular and planar in shape, although this shape may vary. Each battery cell 30, 32 may include a plurality of anodes and cathodes stacked together with an electrolyte inside an insulating envelope or package 34. The package 34 may be constructed of a polymer-coated aluminum foil or another suitable material, for example. Each package 34 may include an inner body portion 36, an outer sealed portion 38 surrounding the inner body portion 36, a first generally planar surface 40, and a second generally planar surface 42 opposite the first surface 40. When assembled, the first and second frames 20, 22 may apply compressive forces (F_{frame}) to the battery cells 30, 32 of about 3 psi, 5 psi, 7 psi, or more, for example, which may improve the ionic conductivity of the battery cells 30, 32.

Each battery cell 20, 22 may include a positive terminal 44 and a negative terminal 46 that extend through the package to communicate with the electrical components inside the package 34. The positive and negative terminals 44, 46 of the battery cells 20, 22 in each individual battery sub-assembly 12 and/or adjacent battery sub-assemblies 12 may be electrically connected together in parallel or series. Suitable electrical arrangements are described in U.S. Patent Application Publication No. 2012/0231318 to Buck et al., the disclosure of which is expressly incorporated herein by reference in its entirety.

Each battery sub-assembly 12 of the battery system 10 may further include a compliant heat exchange assembly 50 sandwiched between the battery cells 30, 32 and the first and second frames 20, 22 of the battery sub-assembly 12. Like the battery cells 30, 32, the compliant heat exchange assembly 50 may be sized to fit within the first and second frames 20, 22 such that the first and second frames 20, 22 surround the compliant heat exchange assembly 50. The heat exchange assembly 50 and cooling methods disclosed herein may share various features in common with the heat exchange member and cooling methods disclosed in U.S. patent application Ser. No. 13/826,982 entitled BATTERY SYSTEM WITH INTERNAL COOLING PASSAGES, filed on Mar. 14, 2013, the disclosure of which is expressly incorporated herein by reference in its entirety.

A first exemplary compliant heat exchange assembly 50 is shown in FIGS. 1-3. The illustrative compliant heat exchange assembly 50 includes a first plate 52 and a second plate 54. The first and second plates 52, 54 may be generally rectangular and planar in shape, although this shape may vary. The first and second plates 52, 54 may be constructed of plastic, metal, or another suitable thermally conductive material.

The illustrative compliant heat exchange assembly 50 also includes one or more compliant members 56 sandwiched between the first and second plates 52, 54. The compliant members 56 may be constructed of a material that provides adequate dimensional compliance and thermal heat rejection. In FIGS. 1-3, the compliant members 56 include strips of foam, for example. Except for the spaced-apart compliant members 56 between the first and second plates 52, 54, the heat exchange assembly 50 may be generally hollow between the first and second plates 52, 54 to define a plurality of heat exchange pathways or conduits 58 therebetween. As shown in FIG. 3, the first and second frames 20, 22 may be open in the areas of conduits 58 to permit a heat exchange medium (e.g., air) to enter and exit each conduit 58.

The compliant heat exchange assembly 50 may have a unitary or multi-piece construction. In the illustrated embodiment of FIG. 1, the first and second plates 52, 54 and the compliant members 56 are separate pieces that are assembled together using adhesive strips (not shown) on the compliant foam members 56, for example. It is also within the scope of the present disclosure that the compliant members 56 may be integrally formed with the first and second plates 52, 54.

The compliant members 56 of the compliant heat exchange assembly 50 may respond to forces and dimensional changes in each battery sub-assembly 12. As discussed above, the first and second frames 20, 22 may apply compressive forces (F_{frame}, to the battery cells 30, 32. The compliant members 56 of the compliant heat exchange assembly 50 may yield to these compressive forces from the frames 20, 22 (F_{frame}). Also, the battery cells 30, 32 may expand and contract during use, varying in thickness by about 2-4%, for example. The compliant members 56 of the compliant heat exchange assembly 50 may yield to forces from the cells 30, 32 (F_{cell}) as the battery cells 30, 32 expand and contract. As the compliant heat exchange assembly 50 yields to these forces (F_{frame} and F_{cell}), the thickness of the heat exchange assembly 50 may vary. However, the overall thickness of the battery sub-assembly 12 may remain stable due to the frames 20, 22. Therefore, the ability for the compliant heat exchange assembly 50 to respond to these forces (F_{frame} and F_{cell}) may help the battery sub-assembly 12 maintain dimensional stability and may stabilize the battery system 10.

According to an exemplary embodiment of the present disclosure, the first and second plates 52, 54 of the compliant heat exchange assembly 50 are generally smooth (i.e., flat) and continuous (i.e., solid). The smooth and continuous surfaces may distribute the compression forces (F_{frame} and F_{cell}) evenly across the battery cells 30, 32. If the first and second plates 52, 54 included gaps, openings, or other irregularities, by contrast, the battery cells 30, 32 could bend or deform, develop internal shorts, and/or suffer performance losses, for example.

The compliant heat exchange assembly 50 may also facilitate cooling of the battery cells 30, 32 in each battery sub-assembly 12. Battery cells 30, 32 generate heat when charged and discharged. This heat may travel through the packaged walls 34 of the battery cells 30, 32 and into the adjacent first and second plates 52, 54 of the compliant heat exchange assembly 50. This heat may also travel into the conduits 58 between the first and second plates 52, 54, where the heat may be carried away by a heat exchange medium (e.g., air) in the conduits 58, such as by convection. In this manner, the compliant heat exchange assembly 50 may serve as a heatsink between the battery cells 30, 32.

According to an exemplary embodiment of the present disclosure, the first and second plates 52, 54 of the compliant heat exchange assembly 50 make direct contact with the packages 34 of the adjacent battery cells 30, 32, and more specifically with the inner body portions 36 of the packages 34 of the adjacent battery cells 30, 32. In the illustrated embodiment of FIG. 3, for example, the first or upper plate 52 of the compliant heat exchange assembly 50 makes direct contact with an upper battery cell 30, and the second or lower plate 54 of the compliant heat exchange assembly 50 makes direct contact with a lower battery cell 32. This direct contact may provide a direct thermal path from the battery cells 30, 32 to the compliant heat exchange assembly 50 to facilitate cooling.

Another exemplary compliant heat exchange assembly 50′ is shown in FIG. 4. In this embodiment, the compliant heat exchange assembly 50′ has a unitary plastic construction, where the compliant members 56′ are extruded along with the first and second plates 52′, 54′. Each compliant member 56′ is illustratively curved (e.g., semicircular), although the shape of each compliant member may vary.

Yet another exemplary compliant heat exchange assembly 50″ is shown in FIGS. 5-7. The compliant heat exchange assembly 50″ of FIGS. 5-7 is similar to that shown in FIGS. 1-3. However, the compliant heat exchange assembly 50″ of FIGS. 5-7 also includes external frames 60″ on external surfaces 62″ of the first and second plates 52″, 54″. The external frames 60″ define pockets 64″ for receiving, centering, and supporting the battery cells 30″, 32″ against the first and second plates 52″, 54″. Like the compliant members 50″ between the first and second plates 52″, 54″, the external frames 60″ on the first and second plates 52″, 54″ may be constructed of foam or another suitable compliant material. The pocket 64″ formed by each external frame 60″ may be sized the same as or slightly smaller than the inner body portion 36″ of the corresponding battery cell 30″, 32″. In this manner, the external frame 60″ may contact, grip, and stabilize the battery cell 30″, 32″. The external frames 60″ may be adhered to or otherwise coupled to the first and second plates 52″, 54″.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A battery system comprising:
a plurality of prismatic battery cells including:
a first cell having a first terminal extending from the first cell; and
a second cell having a second terminal extending from the second cell; and
a heat exchange assembly located between the first and second cells, the heat exchange assembly including:
a first surface facing the first cell;
a second surface facing the second cell; and
at least one compliant member between the first and second surfaces.

2. The battery system of claim 1, wherein the first and second surfaces of the heat exchange assembly are planar.

3. The battery system of claim 1, wherein the first and second surfaces of the heat exchange assembly are continuous.

4. The battery system of claim 1, wherein:
the first surface of the heat exchange assembly is in direct contact with the first cell; and
the second surface of the heat exchange assembly is in direct contact with the second cell.

5. The battery system of claim 1, wherein:
the first surface of the heat exchange assembly includes a first frame that defines a first pocket for receiving the first cell; and
the second surface of the heat exchange assembly includes a second frame that defines a second pocket for receiving the second cell.

6. The battery system of claim 5, wherein the first and second frames are constructed of foam.

7. The battery system of claim 1, wherein at least one heat exchange passageway is defined between the first and second surfaces of the heat exchange assembly.

8. The battery system of claim 1, wherein the at least one compliant member of the heat exchange assembly comprises a foam strip.

9. The battery system of claim 1, wherein the at least one compliant member of the heat exchange assembly is curved.

10. The battery system of claim 1, wherein the at least one compliant member of the heat exchange assembly yields when the heat exchange assembly is compressed between the first and second cells.

11. The battery system of claim 1, wherein the first and second surfaces of the heat exchange assembly comprise plastic or metal.
